(19) United States
(12) Patent Application Publication
(10) Pub. No.: US 2008/0061554 A1
(43) Pub. Date: Mar. 13, 2008

(54) Connector Part

(76) Inventor: Geoffrey James Baker, Hampshire (GB)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/813,609

(22) PCT Filed: Jan. 17, 2006
(86) PCT No.: PCT/GB06/00152

§ 371 Date: Jul. 10, 2007

(30) Foreign Application Priority Data
Jan. 17, 2005 (GB) 0500943.6

(51) Int. Cl. F16L 39/00

(52) U.S. Cl. 285/321

(57) ABSTRACT

The present invention is concerned with a connector and in particular a connector capable of connecting both male to male and female to female parts. The present invention thus provides a connector part (30) including a body-portion (31) and at least one arm (40) that projects from an end of the body-portion (31), the or each arm (40) being arranged such that the connector part (30) can be mated with another, substantially identical connector part (39), so that the or each arm of the connector part (30) interposes the or each arm of the respective other connector part (30), wherein the first-connector part (30) has engagement means (33, 42) operable to be releasably engaged by the or each arm (40) of the substantially identical connector part, thereby fixing it relative to the first-said connector part.

### CROSS-REFERENCE TO RELATED APPLICATIONS

This application is an U.S. national phase application under 35 U.S.C. §371 based upon co-pending International Application No. PCT/GB2006/000152 filed on Jan. 17, 2006. Additionally, this U.S. national phase application claims the benefit of priority of co-pending International Application No. PCT/GB2006/000152 filed on Jan. 17, 2006 and Great Britain Application No. 0500943.6 filed on Jan. 17, 2005. The entire disclosures of the prior applications are incorporated herein by reference. The international application was published on Jul. 20, 2006 under Publication No. WO 2006/075188 A1.

### BACKGROUND OF THE INVENTION

1. Field of the Invention

This invention relates to connector parts and in particular to connector parts for connecting one tubular component to another.

2. Description of the Prior Art

Conventional connection apparatus often includes two mating parts: a male part and a female part. The two parts are usually arranged such that the male part is insertable into the female part and releasably fixable thereto. An example of such connection apparatus is a garden hose, where lengths of hose pipe are usually connectable to one another by the provision of either such a male or female part at each end of the hose lengths. However, connection apparatus such as this is disadvantageous in that a male part may not be connected to another male part; and a female part may not be connected to another female part.

### SUMMARY OF THE INVENTION

It is an object of this invention to address this problem.

According to an aspect of this invention there is provided a connector part including a body portion and at least one arm that projects from an end of the body portion, the or each arm being arranged such that the connector part can be mated with another, substantially identical connector part, so that the or each arm of each connector part interposes the or each arm of the respective other connector part, wherein the first-said connector part has engagement means operable to be releasably engaged by the or each arm of the substantially identical connector part, thereby fixing it relative to the first-said connector part.

Preferably the engagement means are operable by pushing the two connector parts together.

“Substantially identical” is used to refer, for example, to connector parts produced by the same manufacturing process, e.g. produced using the same mould or the same electronically stored instructions for operating a manufacturing machine, and therefore does not exclude connector parts with variations due to manufacturing tolerances or other such unintended variations. This is advantageous in that only one type of connector part need be manufactured, rather than separate male and female type connector parts, thereby reducing the complexity and cost of the manufacturing process. Thus, it will be appreciated that, unless clearly stated to the contrary, features described as being included in the first-said connector part are also included in the substantially identical, mating connector part and vice versa. The engagement means may include catch means by which one or more arms of the mating connector part are fixable relative to the first-said connector part. The engagement means may include at least part of a lip-and-catch arrangement, one of the lip and the catch being provided on the first-said connector part and the other of the lip and the catch being provided on one or more arms of the mating connector part. Preferably, one or more arms of the first-said connector part includes a catch surface and the body portion includes a lip, the catch surface being arranged to be pushed over the lip of the mating connector part into a position in which the catch surface abuts the lip of the mating connector part when the two connector parts are pushed together, such that separation of the two connector parts is resisted by that abutment. The arm or arms may therefore be considered to “latch over” the lip. Preferably the lip is provided around the body portion. Preferably a respective catch surface is provided adjacent a leading edge of each arm or arms.

The body portion may be substantially tubular and may be hollow. Preferably, the body portion is substantially cylindrical. The or each arm is preferably arcuate in cross section and projects from a radially outer surface of the end of the body portion, the inner radius of the or each arm being substantially the same as the outer radius of the body portion such that the or each arm is a sliding fit on the body portion of the mating connector part. The body portion may have a mating surface at the end thereof, the mating surface being substantially midway between the lip and the catch surface of the connector part, such that when that connector part is mated with the other, substantially identical connector part, the two mating surfaces abut one another so as to provide a sealed connection between the two connector parts. The mating surface is preferably a flat annular surface, perpendicular to the axis of the tubular body portion. The mating surface may include a seal, such as an o-ring partially embedded therein. Preferably, the seal is an o-ring wherein said o-ring seal is modified to form a toroidal ring having a generally circular cross section with an integral lip which is angled towards the ring axis and which forms the mating face of the seal. When in an assembled condition the two mating surfaces abut one another such that opposing modified o-rings are compressed to form a seal able to withstand internal pressure by virtue of the opposing integral lip shaped protrusions.

The or each arm may be waisted adjacent the leading edge thereof such that the leading edge is deflectable relative to the remainder of the respective arm thereby facilitating the latching of each catch surface over the respective lip.

Preferably the first-said connector part includes at least two arms. The arms of the first connecting part or of the mating connector may have one or more longitudinal slits provided which improve the flexibility of the arm and aid the formation of the catch-lip engagement.

The first-said connector part may be a single, integral piece. The first-said connector part may include two or more pieces. The first-said connector part preferably includes a tubular, radially innermost piece inside a sleeve, the radially innermost piece including the mating surface and the sleeve including the body portion and the arms. Preferably the radially innermost piece is axially abuttable by the sleeve such that when mated to the mating connector part, the two radially innermost pieces are pressed together at their mating surfaces to create a sealed connection therebetween.

The first-said connector part may include additional engagement means operable to resist the retraction of at least one of the arms of the mating connector part from the first-said connector part by resisting the un-latching of one or more catch surface of the mating connector part from the lip of the first-said connector part. Preferably, the additional engagement means includes a ring operable to surround and radially constrain the radially outermost surfaces of the arms of the mating connector part, thereby preventing the or each catch surface thereof from riding back over the lip. The ring may be releasably locatable in a position in which it radially constrains the arms by the provision of a lip-and-catch arrangement between the ring and the arms. Preferably the ring includes an inwardly-projecting lip adjacent a leading edge of the ring and preferably at least one arm includes a second, cooperating catch surface on its radially outermost surface. Preferably the second catch surface is provided adjacent a mid point of the arm, such that resilience of material of the arm causes the arm to abut both the ring that surrounds it and the body portion with which it is engaged.

In an alternative embodiment, the engagement means may comprise at least one lock ring and an abutment on said at least one arm of the first connector part or mating connector part, said lock ring having a formation which is operable to engage and axially constrain said at least one arm by rotation of said lock ring around its longitudinal axis relative to the first connector part or mating connector part. Preferably the formation on said lock ring includes a helical surface and said abutment on said arm or arms includes a helical surface, said helical surfaces being frictionally engageable during rotation of said lock ring about its longitudinal axis relative to the first connector part or mating connector part so that relative rotation of the lock ring and arms is resisted. Preferably, the lock-ring comprises one or more cutaway sections adjacent the leading edge of the ring which allow the lock-ring to pass over the abutments on the arms of the first connecting part or mating connector.

Preferably the first connecting part may be mated to the mating connector part with both the catch and lip engagement means and the twisting engagement means described above to create a seal connection therebetween. Alternatively, the catch and lip and twisting engagement means may be used independent of one another.

A tertiary lock may be incorporated in the engagement means to provide a more secure seal between the first connecting part and the mating connector part. The tertiary lock may be provided by a further lip and catch arrangement, one of the lip and catch being provided at the end of one or more of the arms of the first connecting part or mating connector and the other of the lip and catch being provided in a corresponding position on the radially internal surface of the locking ring.

Although it is stated above that the first-said connector part is preferably for connecting to another connector part substantially identical to the first-said connector part, the first-said connector part may be for connecting to a further connector part having substantially the same arm arrangement and substantially the same body portion such that the two connector parts can be mated, but the further connector part including further features or structure. For example, a body portion of the further connector part may be integral with tubing used for conveying liquids or gases such as a hose pipe nozzle or a sprinkler head, or, for example, the further connector part may have a body portion that is formed into a right angle.

According to another aspect of this invention there are provided two connector parts, each connector part being substantially identical to the respective other connector part, and each connector part including a body portion and at least one arm that projects from an end of the body portion, the or each arm of each connector part being arranged such that each connector part can be mated with the respective other connector part so that the or each arm of each connector part inter-digitates with the or each arm of the respective other connector part, wherein each connector part has engagement means operable to be releasably engaged by the or each arm of the respective other connector part, thereby fixing the two connector parts together.

Optional features of the first-said connector of the one aspect of this invention may also be optional features of each of the connector-parts of the other aspect of this invention.

### BRIEF DESCRIPTION OF THE DRAWINGS

Specific embodiments of this invention are now described by way of example only and with reference to the accompanying drawings, in which:

FIG. 1 is a sectional view of two mated connector parts employing a push engagement means;

FIG. 2 is a plan view and a part-sectional view of a radially innermost piece of one of the connector parts;

FIG. 2a is an end view of the radially innermost piece;

FIG. 2b is a detailed sectional view of part of the radially innermost piece;

FIG. 3 is a sectional view of a sleeve of the connector part;

FIG. 3 a is a plan view of the sleeve;

FIG. 3b is an end view of the sleeve;

FIG. 4 is a sectional view of a lock ring of the connector part.

FIG. 5 is a sectional view of two mated connector parts employing a twisting engagement means.

FIG. 5a is an enlarged sectional view of opposing o-lip seals at abutting mating surfaces.

FIG. 6 is a detailed sectional view of the body portion of the connector part.

FIG. 6a is a plan view of an arm of a connector part showing a helical radially outermost surface.

FIG. 6b is an enlarged sectional view of a groove provided at the mating surface.

FIG. 6c is an end view of an arm of a connector part.

FIG. 7 is a sectional view of a lock ring with helical radially innermost surface.

FIG. 7a is a scrap view in the direction of arrow A in FIG. 7 showing the helical radially innermost surface.

FIG. 7b is an end view of the lock ring.

FIG. 8 is a cross section of a toroidal shaped o-lip seal.

FIG. 8a is an enlarged sectional view of a toroidal shaped o-lip seal.

### DESCRIPTION OF THE PREFERRED EMBODIMENT

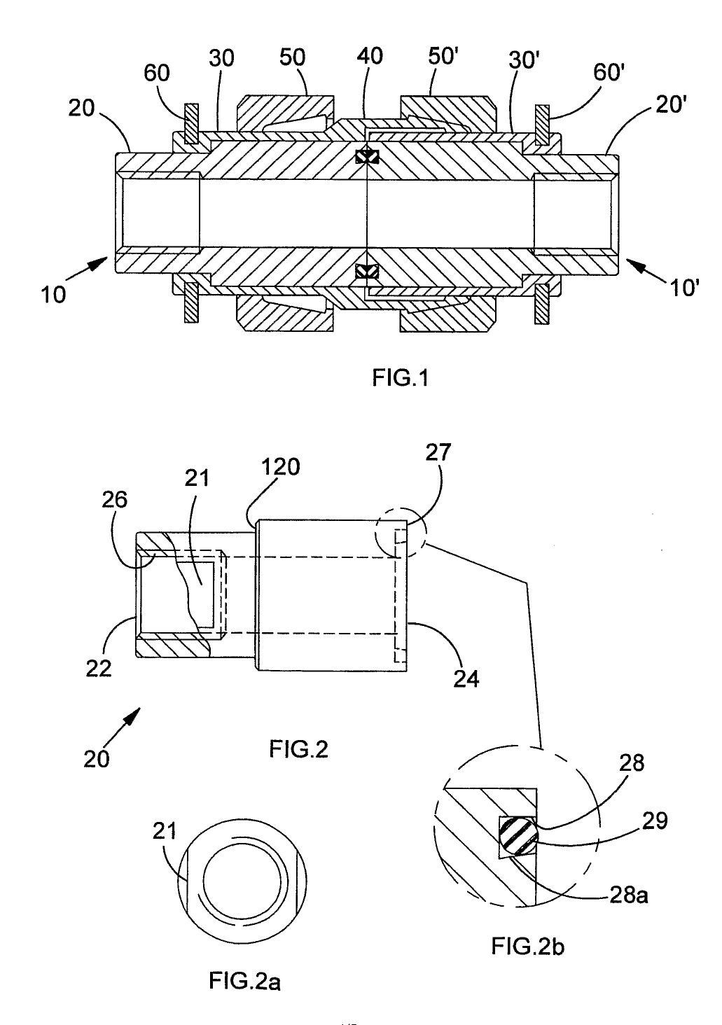

FIG. 1 shows two generally cylindrical connector parts 10, 10′. The connector parts 10, 10′ are shown in cross section, the section being taken along a longitudinal axis of the connector parts 10, 10′. The two connector parts 10, 10′ are substantially identical and so the structure of one 10 of the connector parts 10, 10′ only will be described for simplicity, it being understood that the structure of the other connector part 10′ is the same, within the limits of normal and acceptable manufacturing variation.

The connector part 10 includes a radially innermost piece 20, a sleeve 30 and a lock ring 50.

The radially innermost piece 20 is substantially cylindrical and is formed of a single piece of injection-moulded plastic, for example an acetal homopolymer plastic, such as DELRIN. Such plastics exhibit good resistance to fatigue and tend not to absorb water. As is shown more clearly in FIG. 2, the radially innermost piece 20 has a non-mating end 22 and a mating end 24. The internal diameter of the cylindrical radially innermost piece 20 is constant along the length of the radially innermost piece 20, however a screw thread 26 is formed in the inner surface of the radially innermost piece 20 at its non-mating end 22. The screw thread 26 is for connecting the non-mating end 22 of the radially innermost piece 20 to apparatus (not shown) that is to be connected to other apparatus (not shown) by means of the two connector parts 10,10′. For example, an end of a length of garden hose (not shown) may include a cooperating screw thread on the outside thereof that can be screwed into the non-mating end 22 of the radially innermost piece 20. Alternatively, an end of a mechanical transmission shaft (not shown) may be screwed into the non-mating end 22 of the radially innermost piece 20.

As shown in FIG. 2, the outside surface of the radially innermost piece 20 is stepped so as to be of lesser diameter at the non-mating end 22 than at the mating end 24 thereof, with a step 120 therebetween. To facilitate screwing such apparatus as that mentioned above to the non-mating end 22 of the radially innermost piece 20, the outer surface of the radially innermost piece 20 includes two parallel and radially opposite flat surfaces 21 adjacent the non-mating end. These flat surfaces 21 are shown in FIG. 2A and are arranged for gripping by an operator or placing between the jaws of a wrench, so as to gain angular purchase on the radially innermost piece 20.

With reference to FIG. 2, the mating end 24 of the radially innermost piece 20 includes a mating surface 27. The mating surface 27 is a flat, annular surface that lies in a radial plane of the radially innermost piece 20. A continuous annular channel 28 is formed in the mating surface 27 so as to have an opening that projects axially. The channel 28 houses a resiliently compressible o-ring seal 29 that, in an uncompressed condition, projects slightly beyond the opening of the channel 28. A radially innermost wall 28A of the channel 28 is oblique to the axis of the radially innermost piece 20 such that the channel 28 is narrower towards its opening. This serves to retain the seal 29 in the channel 28.

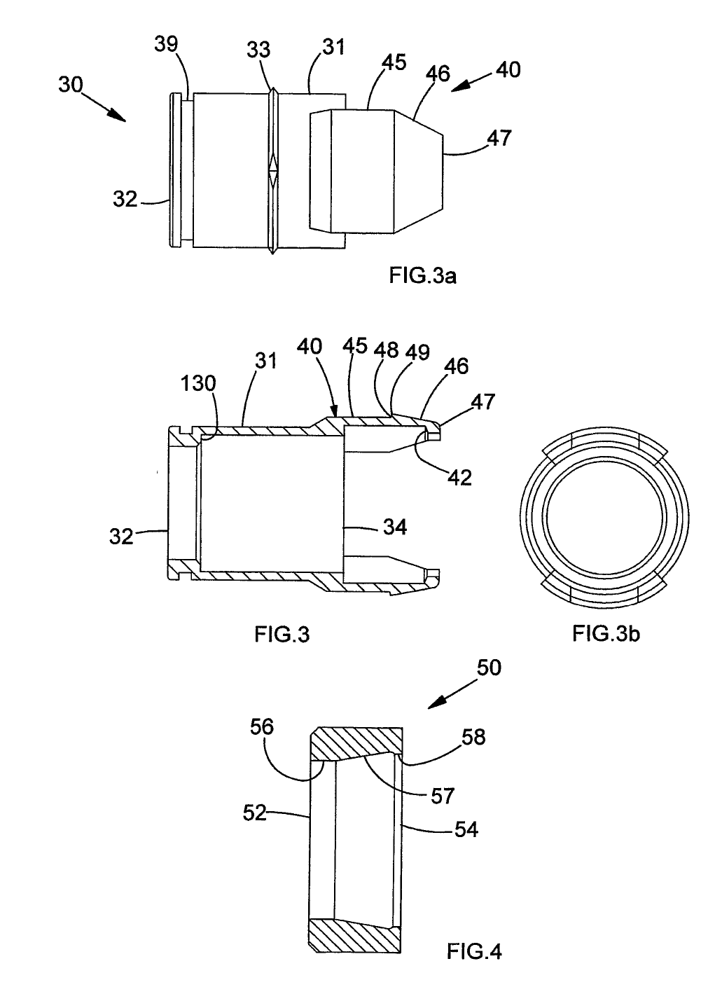

FIG. 3 shows the sleeve 30 in more detail. The sleeve 30 is also a single piece of injection-moulded DELRIN. The sleeve 30 includes a cylindrical portion 31 with two arms 40 projecting from a mating end 34 of the cylindrical portion 31. The cylindrical portion 31 of the sleeve 30 is for fitting closely around the outside of the radially innermost piece 20. Thus, the inside surface of the cylindrical portion 31 is stepped so as to be of lesser diameter at a non-mating end 32 thereof than at a mating end 34 thereof, with a step 130 therebetween. When the sleeve 30 is fitted around the outside of the radially innermost piece 20, the mating surface 27 of the radially innermost piece 20 projects beyond the mating end 34 of the sleeve 30.

The cylindrical portion 31 of the sleeve 30 has an outside that is of constant diameter, save for the provision of a ridge-like lip 33 and a circlip groove 39. These are shown in FIG. 3A. The lip 33 runs circumferentially around the outside of the cylindrical portion 31 and is v-shaped in cross-section. The lip 33 is positioned substantially midway along the length of the cylindrical portion 31, but at a specified axial distance from the step 130 of the inside surface of the cylindrical portion 31. The circlip groove 39 runs circumferentially around the outside of the cylindrical portion 31, adjacent the non-mating end 32 thereof.

Each arm 40 includes a base portion 45 and a tip portion 46. Each base portion 45 projects from the cylindrical portion 31 of the sleeve 30, and each tip portion 46 projects from the respective base portion 45 to a respective tip 47. The two arms 40 are diametrically opposed, project axially and are arcuate in cross section so as to be concentric with the cylindrical portion 31. The arcuate width of the tip portion 46 of each arm 40 tapers towards a shorter arcuate width at the tip 47 of that arm 40. This reduction in the arcuate width of each tip portion 46 is intended to promote bending and ease of engagement of the tip portion 46 for reasons that are described below.

With reference to FIG. 3, the outside surface of the base portion 45 of each arm 40 is of constant radius. The outside surface of each base portion 45 is joined to the outside surface of the respective tip portion 46 by a chamfer 48 such that the radius increases from the base portion 45 to the tip portion 46. The outside surface of each tip portion 46 tapers from the respective chamfer 48 to a smaller radius at the respective tip 47. Thus, each chamfer 48 and the respective tip portion 46 meet at a respective ridge 49.

The inside radius of each of the arms 40 is such that they would be a sliding fit over the lip 33. At the tip portion 46 of each arm 40, structure thereof projects radially inwards so as to form a respective, inwardly-projecting, arcuate, shallow flange 42. The radius of each shallow flange 42 is such that the shallow flanges 42 would be a sliding fit over the outside of the cylindrical portion 31.

FIG. 4 shows the lockring 50, which is also a single piece of injection-moulded DELRIN. The lockring 50 is substantially cylindrical and has a mating end 54 and a non-mating end 52. The internal surface of the lockring 50 includes a portion 56 of constant radius at the non-mating end 52, the radius being such that this portion 56 is a sliding fit on the cylindrical portion 31 of the sleeve 30. The internal surface of the lockring 50 also includes a mid portion 57 that is oblique to the axis of the lockring 50 such that the internal radius thereof increases from the portion of constant radius 56 to the mating end 54. An inwardly-projecting lip 58 is provided at the mating end 54. The lip 58 runs circumferentially around the inside of the lockring 50. The radius of the lip 58 is such that it is an interference fit with respect to the ridge 49 of each arm 40 and such that it is a sliding fit on the mid portion 45 of each arm 40.

FIG. 1 shows an assembled arrangement of the connector part 10, in which the radially innermost piece 20, the sleeve 30 and the lockring 50 are fitted to one another so as to be co-axial. The radially innermost piece 20 is placed inside the sleeve 30 with the step 120 of the former abutting the step 130 of the latter. This results, as stated above, in the mating surface 27 of the radially innermost piece 20 projecting beyond the mating end 34 of the cylindrical portion 31 of the sleeve 30. The lockring 50 is placed around the sleeve 30, with the mating end 54 of the lockring 50 projecting in the same direction as the mating end 34 of the sleeve 30. A circlip 60 is then placed in the circlip groove 39 of the sleeve 30 to retain the lockring 50 around the sleeve 30. In operation, the one connector part 10 is connected to the other connector part 10′. The two connector parts 10, 10′ are presented to one another so as to be 90 degrees out of alignment, i.e. so that the arms 40 of the one connector part 10 interpose the arms 40′ of the other 10′. The two connector parts 10, 10′ are pressed together until the arcuate shallow flange 42, 42′ of each arm 40, 40′ has passed over the lip 33′, 33 of the respective other sleeve 30′, 30. In so doing, the arms 40, 40′ bend radially outwards so that the shallow flanges 42, 42′ “latch” over the respective lip 33′, 33. The shallow flanges 42,42′ come to rest in abutment against the respective lip 33′, 33. Also, the arcuate shallow flange 42, 42′ of each arm 40, 40′ presses inwardly on the cylindrical portion 31′, 31 of the respective other sleeve 30′, 30. Thus, the shallow flanges 42, 42′ act as catch surfaces. This provides both axial and radial location and results in the mating surface 27, 27′, and hence the o-ring seal 29, 29′ therein, of each radially innermost piece 20, 20′ being pressed firmly together so that a fluid tight seal exists between the two radially innermost pieces 20, 20′. This is the primary means of connection.

Although not a feature of this embodiment, it is envisaged that a resiliently compressible member, such as a wave washer may be provided between the respective two abutting steps 120, 130; 120′, 130′ of each connector part 10, 10′. The characteristics of such a resiliently compressible member would affect the pressure between the mating surfaces 27, 27′ of mating connector parts 10, 10′ and resiliently compressible members may be selected with this in mind.

Each lockring 50, 50′ is then pushed towards the respective other sleeve 30′, 30 so that the inwardly-projecting lip 58, 58′ of each lockring 50, 50′ passes over the tip portion 46′, 46 of each of the arms 4O′, 4O of the respective other sleeve 30′, 30. In so doing, the arms 40, 40′ are deflected radially inwards until each inwardly-projecting lip 58, 58′ has passed over the ridge 49′, 49 of the respective arm 40′, 40, whereupon the arms 40,40′ at least partially recover their shape. In this position, the inwardly-projecting lip 58, 58′ lies across the outermost surface of the base portion 45′, 45 of the arms 40′, 40 of the respective other sleeve 30′, 30. Thus, the lockrings 50, 50′ serve to prevent the disconnection of the two sleeves 30, 30′ and hence of the two connector parts 10, 10′ by preventing the arcuate shallow flanges 42, 42′ from moving radially outwards so that they may pass back over the lip 33′, 33 of the respective other sleeve 30′, 30. This is the secondary means of connection and may be considered an auxiliary mechanism to the primary means of connection.

In this embodiment, the base portion 45, 45′ of each arm 40, 40′ is of a width such that, once mated, the base portions 45, 45′ form a complete cylinder of interposed arms 40, 40′. This provides angular location of the one connector part 10 relative to the other 10′ and also serves to provide additional radial location.

It is envisaged that each inwardly-projecting lip 58, 58′ may be an interference fit against the base portion 45 of the respective arms 40′, 40 that are surrounded thereby. This would result in the arms 40, 40′ being continually pressed against the cylindrical portion 31 of the respective sleeve 30, thereby further preventing unwanted disconnection.

It will be appreciated that the connection operation as described above is accomplished by pushing first the sleeves 30, 30′ together and then pushing the lockrings 50, 50′ together. This is both simple and quick. The two connector parts 10, 10′ are disconnected by reversing the procedure described above. As described above, the connector parts 30, 30′ may have respective apparatus (not shown) connected to the radially innermost piece 20, 20′ of each connector part 10, 10′. For example, piping for carrying liquids and/or gases may be attached to each radially innermost piece 20, 20′. Alternatively, conduit for carrying electrical or some such other cable by be so joined. Mechanical drive shafts for rotary, linear or some such other form of motion may also be connected in this way. It is envisaged that alternative connecting means to that of the screw thread 26 may be used to connect one or both of the connector parts 10, 10′ to such apparatus.

In an alternative and simplified embodiment, each identical connector part may not include a lockring, but may include only a respective radially innermost piece and sleeve, the radially innermost piece and sleeve being as described above.

In another alternative and even simpler embodiment, each identical connector part may include the sleeve only. This other alternative embodiment might be suitable for an application in which fluid-tight sealing is not needed. Alternatively, it is envisaged that the mating end of the cylindrical portion of each sleeve may be provided with an o-ring seal, so that this other alternative embodiment might be used in applications where fluid-tight sealing is needed.

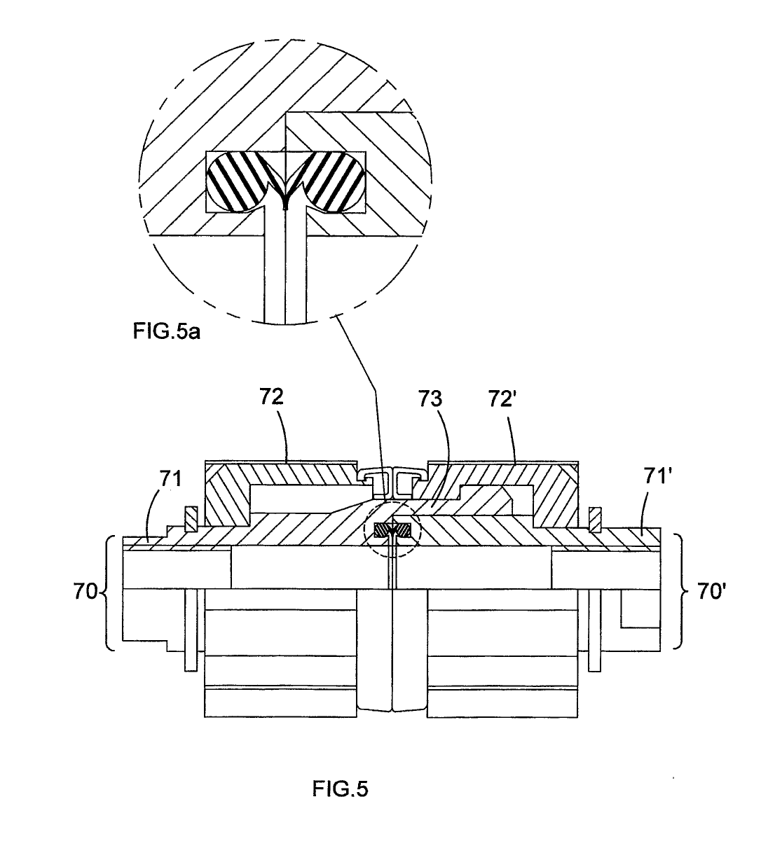

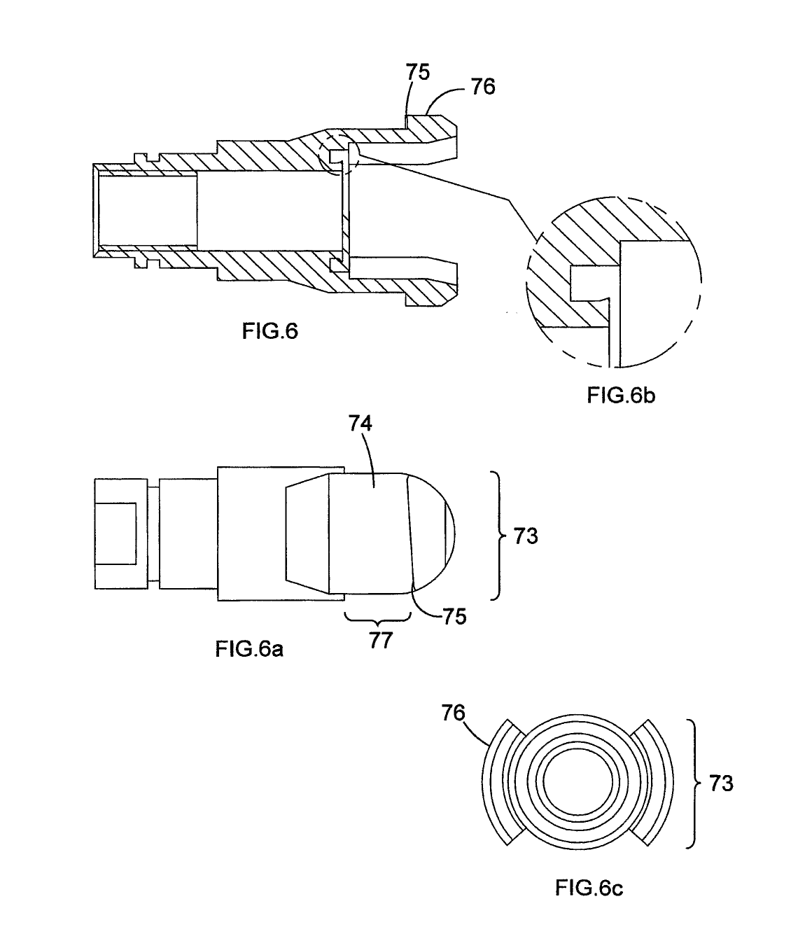

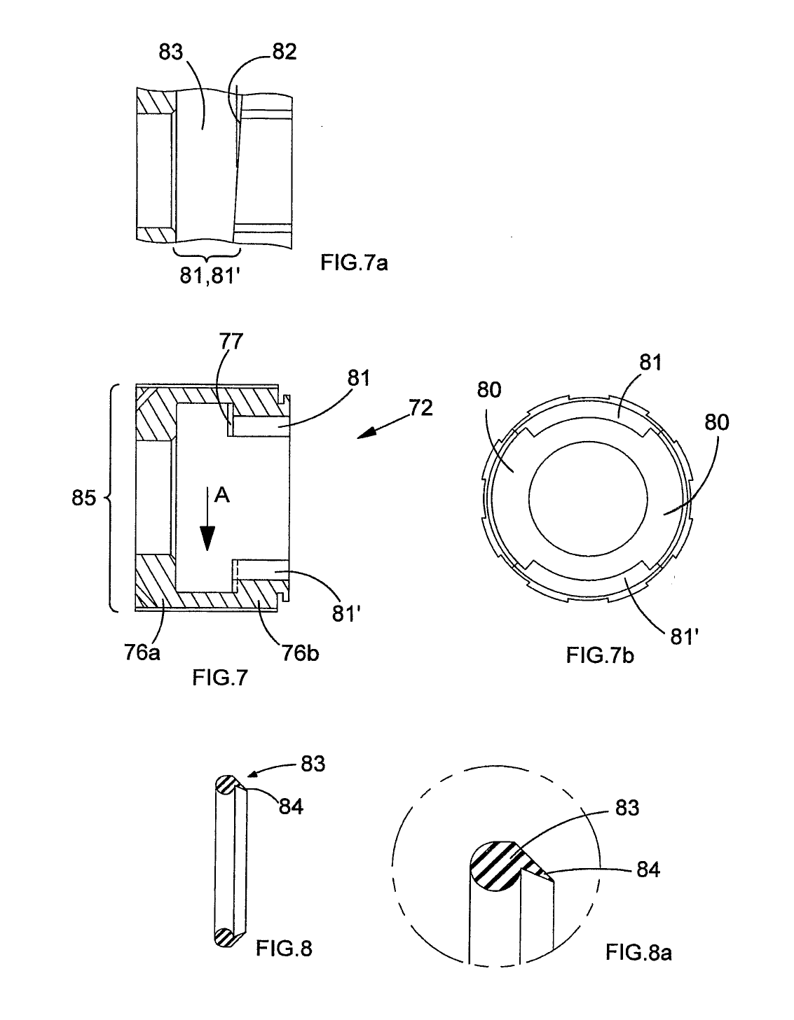

An alternative embodiment is shown in FIG. 5. This includes a connector part 70, which has a radially innermost piece 71 which is generally similar to the radially innermost part 20 and sleeve 30 described in FIG. 1 above. In this embodiment, the engagement means is provided through a lock-ring 72 and arms 73 of the connector part 70. The lock-ring 72 surrounds and restricts the arms 73 of the connecting part 70 to draw and hold the connector part 70 and mating connector part 70′ together. This engagement means is shown in more detail in FIG. 6 and FIG. 7. Each arm 73 has a part cylindrical portion 74 which terminates in a radially protruding lip 76 at its mating end. The lip 76 has an annular, rear face 75 which extends along a helical path 77 and has a slight axial lead along the radially outermost surface of the cylindrical portion 74.

The lock ring 72 is shown in FIG. 7. The lock ring 72 comprises a generally cylindrical tubular member 85 which has a first inwardly directed, annular flange at its non-mating end 76a, and a second inwardly directed annular flange at its mating end 76b. The second annular flange has two angularly extending spaced cut out portions 80 which define angularly spaced flange portions 81, 81′. The angular extent of each cut out portion 80 corresponds to the angular extent of each arm 73. The cutaway portions 80 are thus able to accommodate each respective arm 73 of the connector part 70 when the lock-ring 72 is slid over an opposing connector part 70′. The end face 82 of each flange portion 81 extends along a helical path at a slight axial lead and is thus complementary to the helical face 77 provided on the radially outmost surface of the cylindrical portion 74.

In operation, the one connector part 70 and the other connector part 70′ are presented to one another to form a complete cylinder of interposed arms as described above in relation to the first embodiment. Each lock ring 72 is then pushed towards the respective other connector part 70, 70′ so that an arm of the respective other connector part 70, 70′ is accommodated in each respective cutaway portion 80 such that each lip 76 is passed completely through the cut out 80. Each lock ring 72 is then twisted through 90° around its longitudinal axis so that each lip 76 moves behind its associated flange portion 81 into the axial space between the flange 76a and flange portion 81. During this operation, the helical face 75 of each lip 76 comes into frictional engagement with the helical face 82 of the associated flange portion 81 in order to lock the two together. Thus, the lock rings 72 serve to prevent the disconnection of the two connector parts 70, 70′ by preventing the arms 73 of each respective connector part from moving away from the opposing arms 73′ of the other connector part. Further, the complementary helical faces 75 and 82 serve to pull the mating surfaces 47, 47′ of the connectors together when they are engaged to ensure a tight seal.

FIG. 8 shows a cross section through an olip seal 83. The olip seal 83 is manufactured from a plastics or rubber material such a VITON. The olip seal 83 is toroidal and has an integral lip shaped protrusion 84 angled towards the toroidal axis. In use, an olip seal 83 is located in a groove in the mating surface 47 of each connecting part 70 such that the integral lip shaped protrusion 84 points away from the main body the connector part 70. Thus, when in its connected state, opposing olips 83 form a tight seal by opposing lip shaped protrusions 84 being compressed against each other. The seal formed is thus able to withstand increased internal pressures, should they arise, by virtue of the resistance generated by the opposing lips shaped protrusions 84.

1-19. (canceled)

20: A connector part for connecting one tubular component to another, said connector part comprising:
a body portion; and
at least one arm that projects from an end of said body portion, said arm being arranged such that said connector part can be mated with another, substantially identical connector part, so that said arm of each connector part interposes said arm of the respective other connector part;
wherein said connector part has engagement means operable to be releasably engaged by the arm of the substantially identical connector part, thereby fixing it relative to said connector part.

21: The connector part as set forth in claim 20, wherein said engagement means is operable by pushing together said connector part and a substantially identical connector part.

22: The connector part as set forth in claim 21, wherein said engagement means includes at least part of a lip and catch arrangement, one of said lip and catch arrangement being provided on said connector part and said other of said lip and catch arrangement being provided on one or more arms of a mating connector part.

23: The connector part as set forth in claim 22, wherein said arm of said connector part includes a catch surface and said body portion includes said lip, said catch surface being arranged to be pushed over the lip of the mating connector part into a position in which said catch surface abuts the lip of the mating connector part when the two connector parts are pushed together, such that the separation of the two connector parts is resisted by said abutment.

24: The connector part as set forth in claim 23, wherein said lip is provided around said body portion.

25: The connector part as set forth in claim 24, wherein said catch surface is provided adjacent a leading edge of said arm.

26: The connector part as set forth in claim 25 further comprising an additional engagement means operable to restrict the retraction of the arm of the mating connector part from said connector part by resisting the unlatching of one or more catch surfaces of the mating connector part from said lip of said connector part.

27: The connector part as set forth in claim 26, wherein said additional engagement means includes a ring operable to surround and radially constrain the radially outermost surfaces of the mating connector part, thereby preventing said catch surface thereof from riding back over said lip.

28: The connector part as set forth in claim 27, wherein said ring includes an inwardly projecting lip adjacent a leading edge of said ring and preferably said at least one arm includes a second, cooperating catch surface on its radially outermost surface.

29: A connector part comprising:
a body portion;
at least one arm that projects from an end of said body portion, said arm being arranged such that said connector part can be mated with another, substantially identical connector part, so that said arm of each connector part interposes said arm of the respective other connector part; and
an engagement means operable to be releasably engaged by said arm of the substantially identical connector part, thereby fixing it relative to the first said connector part, said engagement means comprises at least one lock ring and an abutment on said at least one arm of the first said connector part or mating connector part, said lock ring having a formation which is operable to engage and axially constrain said at least one arm by rotation of said lock ring around its longitudinal axis relative to the first said connector part or mating connector part.

30: The connector part as set forth in claim 29, wherein the formation on said lock ring includes a helical surface and said abutment on said arm or arms includes a helical surface, said helical surfaces being frictionally engagable during rotation of said lock ring about its longitudinal axis relative to the first said connector part or mating connector part so that relative rotation of said lock ring and arms is resisted.

31: The connector part as set forth in claim 30, wherein said lock-ring comprises one or more cutaway sections adjacent the leading edge of said ring which allow said lock-ring to pass over said abutments on said arm of the first said connecting part or mating connector.

32: The connector part as set forth in claim 31, wherein said arm is arcuate in cross section and projects from a radially outer surface of the end of said body portion, an inner radius of said arm being substantially the same as an outer radius of said body portion such that said arm is a sliding fit on said body portion of the mating connector part.

33: The connector part as set forth in claim 29, wherein said body portion has a mating surface at an end thereof, said mating surface being substantially midway between a lip and a catch surface of said connector part, such that when said connector part is mated with the other substantially identical connector part, said two mating surface abut one another so as to provide a sealed connection between the connector parts.

34: The connector part as set forth in claim 33, wherein said mating surface comprises a groove having an o-ring seal provided therein.

35: The connector part as set forth in claim 34, wherein said o-ring seal is modified to form a toroidal ring having a generally circular cross section with an integral lip which is angled towards the ring axis and which forms the mating face of the seal.

36: A connector part system comprising:
at least two connector parts, each connector part being substantially identical to the respective other connector part, and each connector part comprising: a body portion; and at least one arm that projects from an end of said body portion, said arm of each connector part being arranged such that each connector part can be mated with the respective other connector part so that said arm of each connector part interdigitates with said arm of the respective other connector part, wherein each connector part has engagement means operable to be releasably engaged by said arm of the respective other connector part, thereby fixing the two connector parts together.

37: The connector part as set forth in claim 36, wherein said body portion is integral with tubing used for conveying fluids.

38: The connector part as set forth in claim 36, wherein said engagement means includes at least part of a lip-and-catch arrangement, one of said lip and catch being provided on one of said connector parts and said other of the lip and catch being provided on said arm of the mating connector part.

39: The connector part as set forth in claim 36, wherein said engagement means comprises at least one lock ring and an abutment on said at least one arm of one of said connector parts, said lock ring having a formation which is operable to engage and axially constrain said at least one arm by rotation of said lock ring around its longitudinal axis relative to said connector part.
